(19) United States
(12) Patent Application Publication
(10) Pub. No.: US 2015/0371543 A1
(43) Pub. Date: Dec. 24, 2015

(54) SAFE FLIGHT-PATH SEARCH ENGINE SYSTEM AND METHOD

(71) Applicants: Jose Luis Ismael Amodio Leon, Maracay (VE); Raj V. Abhyanker, Cupertino, CA (US)

(72) Inventors: Jose Luis Ismael Amodio Leon, Maracay (VE); Raj V. Abhyanker, Cupertino, CA (US)

(21) Appl. No.: 14/311,248

(22) Filed: Jun. 21, 2014

(51) Int. Cl. G08G 5/00

(52) U.S. Cl. CPC G08G 5/0034; G08G 5/0039; G08G 5/0069; G08G 5/006; G08G 5/0004

(57) ABSTRACT

Disclosed are a method and a system of a safe flight-path search engine, according to one embodiment. In one embodiment, a method of a safe-flight server includes generating a safe-flying route of an aerial vehicle based on a position of a set of obstacles in a neighborhood area, creating a flight-path map comprising a set of flight paths of the aerial vehicle in the neighborhood area based on the generation of the safe-flying route, and publishing the flight-path map over an Internet protocol based network (such that the flight-path map is sharable with a plurality of searching users of a flight-path search engine that generates at least one flight path option between a starting location and an ending location of the aerial vehicle). The set of obstacles includes any of a tree, a utility pole, a street light, a building, a telephone line, and a utility line.

### FIELD OF TECHNOLOGY

This disclosure relates generally to the technical fields of communications and, in one example embodiment, to a method, apparatus, and system of a safe flight-path search engine.

### BACKGROUND

Aerial vehicles, users of aerial vehicles, and/or flight path planning systems may face challenges when generating flight paths that account for obstacles (e.g., trees, buildings, and/or utility poles) in a neighborhood area. There may be no effective system for users to plan, share, and/or use flight information with and/or from other users. This may result in duplication of efforts and/or dysfunctional aerial spaces (e.g., uncoordinated flight paths and/or aerial vehicles taking inefficient paths).

Traditional flight planning methods may not account for changes in obstacle landscapes (e.g., tree removals and/or new buildings added). Independent users and/or owners of aerial vehicles may be forced to account for these changes individually and/or develop flight plans for each desired flight. This may take and/or duplicate considerable resources and/or time. Flying aerial vehicles in neighborhood areas may be difficult and/or dangerous as a result.

### SUMMARY

A method, device and system of a safe flight-path search engine are disclosed. In one aspect, a method of a safe-flight server includes generating a safe-flying route of an aerial vehicle based on a position of a set of obstacles in a neighborhood area, creating a flight-path map comprising a set of flight paths of the aerial vehicle in the neighborhood area based on the generation of the safe-flying route, and publishing the flight-path map over an Internet protocol based network (such that the flight-path map is sharable with a plurality of searching users of a flight-path search engine that generates at least one flight path option between a starting location and an ending location of the aerial vehicle). The set of obstacles includes any of a tree, a utility pole, a street light, a building, a telephone line, and a utility line.

A safe-flying altitude of the aerial vehicle may be calculated based on the position of an obstacle (e.g., the tree, the utility pole, the street light, the building, the telephone line, and/or the utility line) in the neighborhood area. Aerial vehicles may be permitted to utilize the flight-path map when planning flight paths in the neighborhood area. An initial flight path may be created based on a sensing technology to detect obstacles in a region between 0 feet and 200 feet above a ground in the neighborhood area. The neighborhood area may be an urban neighborhood setting, a rural setting, and/or a suburban neighborhood setting.

The initial flight path may be refined to create an updated flight path based on feedback received from other aerial vehicles traveling the initial flight path encountering obstacles. The flight-path map may be automatically updated based on the updated flight path. An estimated flight time may be calculated from the starting location to the ending location of the aerial vehicle requesting to traverse locations on the flight-path map.

A congestion between the starting location and the ending location may be determined based on the feedback received from aerial vehicles traveling the initial flight path encountering delays. A set of encountered obstacles and/or encountered delays may be determined based on at least one sensor of a traversing aerial vehicle. The at least one sensor may include an ultrasound sensor, a radio frequency sensor, a laser sensor, a radar sensor, an optical sensor, a stereo optical sensor, and/or a LIDAR sensor. The flight-path map may be published through a computing device and/or a mobile device to the plurality of searching users of a map-sharing community. The plurality of searching users may be permitted to track the traversing aerial vehicle while in flight through a map view of the computing device and/or the mobile device.

In another aspect, a method of a safe-flight server includes generating a safe-flying route of an aerial vehicle based on a position of a set of obstacles in a neighborhood area, creating a flight-path map comprising a set of flight paths of the aerial vehicle in the neighborhood area based on the generation of the safe-flying route, refining an initial flight path to create an updated flight path based on feedback received from other aerial vehicles traveling the initial flight path encountering obstacles, and automatically updating the flight-path map based on the updated flight path. The set of obstacles includes any of a tree, a utility pole, a street light, a building, a telephone line, and a utility line. The method may publish the flight-path map over an Internet protocol based network in a manner such that the flight-path map is sharable with users of a flight-path search engine that generates at least one flight path option between a starting location and an ending location of the aerial vehicle.

In yet another aspect, a system includes an aerial vehicle, an Internet protocol based network, and a safe-flight server to generate a safe-flying route of the aerial vehicle based on a position of a set of obstacles in a neighborhood area, create a flight-path map comprising a set of flight paths of the aerial vehicle in the neighborhood area based on the generation of the safe-flying route, and publish the flight-path map over the Internet protocol based network in a manner such that the flight-path map is sharable with a plurality of searching users of a flight-path search engine that generates at least one flight path option between a starting location and an ending location of the aerial vehicle. The set of obstacles includes any of a tree, a utility pole, a street light, a building, a telephone line, and a utility line.

An altitude algorithm may calculate a safe-flying altitude of the aerial vehicle based on the position of an obstacle (e.g., the tree, the utility pole, the street light, the building, the telephone line, and/or the utility line) in the neighborhood area. A permission algorithm may permit aerial vehicles to utilize the flight-path map when planning flight paths in the neighborhood area. A creation algorithm may create an initial flight path based on a sensing technology to detect obstacles in a region between 0 feet and 200 feet above a ground in the neighborhood area. The neighborhood area may be in an urban neighborhood setting, a rural setting, and/or a suburban neighborhood setting.

A refinement algorithm may refine the initial flight path to create an updated flight path based on feedback received from other aerial vehicles traveling the initial flight path encountering obstacles. An update algorithm may automatically update the flight-path map based on the updated flight path. An estimation algorithm may calculate an estimated flight time from the starting location to the ending location of the aerial vehicle requesting to traverse locations on the flight-path map.

A delay algorithm may determine a congestion between the starting location and the ending location based on the feedback received from aerial vehicles traveling the initial flight path encountering delays. A set of encountered obstacles and/or encountered delays may be determined based on at least one sensor of a traversing aerial vehicle. The at least one sensor mat include an ultrasound sensor, a radio frequency sensor, a laser sensor, a radar sensor, an optical sensor, a stereo optical sensor, and/or a LIDAR sensor. A publish algorithm may publish the flight-path map through a computing device and/or a mobile device to the plurality of searching users of a map-sharing community. A tracking algorithm may permit the plurality of searching users to track the traversing aerial vehicle while in flight through a map view of the computing device and/or the mobile device.

In some aspects a social network server includes a method through which a user of the social network server may register an ownership interest in a real property. The user of the social network server may specify at least one of a permission, a restriction and a rule regarding a flight of the aerial vehicle in an airspace immediately above to the property such that other users of the social network are provided an access privilege and/or denied the access privilege to operate aerial devices in the airspace above the property. The permission, the restriction, and the rule may be entered into a safe-flight server database and associated with the airspace above the property. A flight-path generator algorithm may be applied to ensure at least one of the permission, the restriction, and the rule associated with the airspace above the property conforms to a rule and/or a regulation of a regulatory entity. The social network server may be associated with a geospatial social network. The social network server may verify the ownership interest of the user registering the ownership interest in the real property through a property ownership verification method.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a network view showing a safe-flying route being generated by a safe-flight server and a flight-path map, created based on the generation of the fast-flying route, being published through an Internet protocol based network to a plurality of searching users in a map-sharing community, according to one embodiment.

FIG. 2 is an exploded view of the safe-flight server of FIG. 1, according to one embodiment.

FIG. 3 is an update view of an initial flight path being updated based on a feedback 304 communicated from the autonomous vehicle to the safe-flight server of FIG. 1, according to one embodiment.

FIG. 4 is a table view illustrating the data relationships between a searching user, the aerial vehicle, and the flight-path, according to one embodiment.

FIG. 5 is a user interface view of a mobile device of a searching user displaying a map view, according to one embodiment.

FIG. 6 is a user interface view of the searching user of FIG. 5 selecting a flight-path on a computing device using a flight-path search engine, according to one embodiment.

FIG. 7 is a critical path view illustrating a flow based on time in which critical operations of the safe flight-path search engine of FIG. 1 occur, according to one embodiment.

FIG. 8 is a process flow of the safe flight-path search engine of FIG. 1, according to one embodiment.

Other features of the present embodiments will be apparent from the accompanying drawings and from the detailed description that follows.

### DETAILED DESCRIPTION

Disclosed are a method and system of a safe flight-path search engine, according to one embodiment.

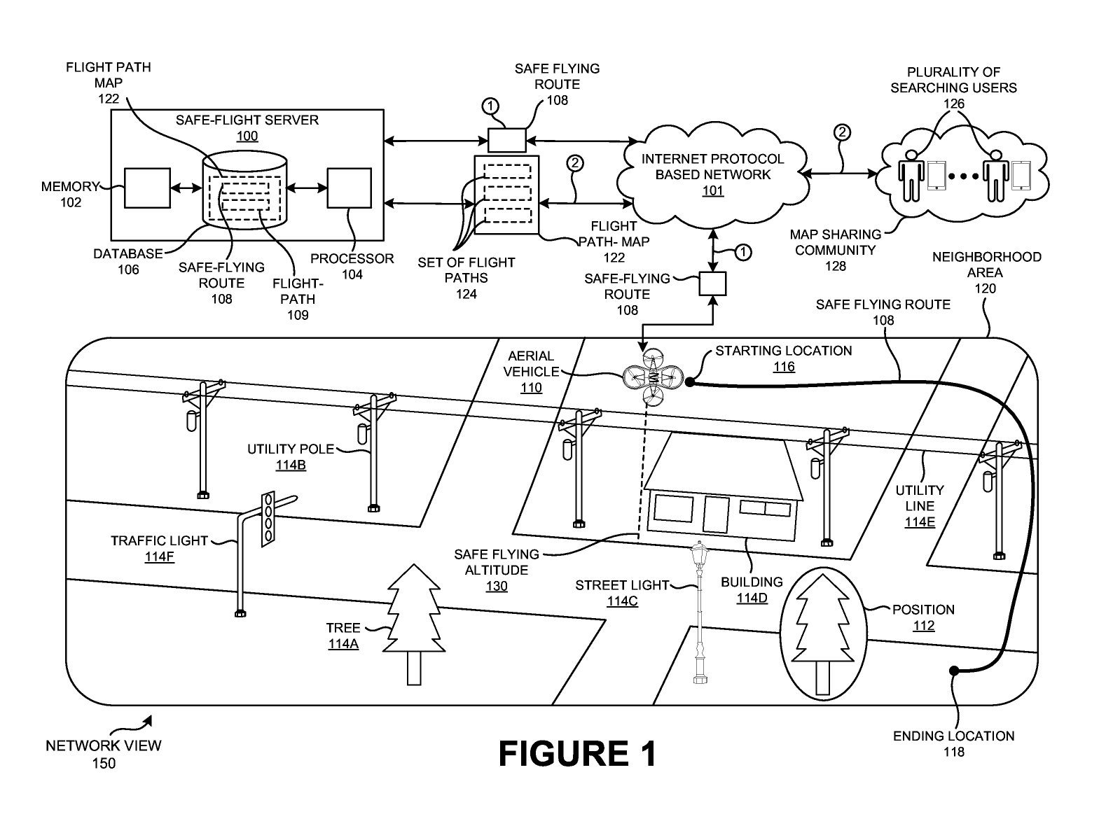

In one embodiment, a social network server (e.g., the social network server may embedded in the safe flight server 100, and/or may be separate from it and communicatively coupled with the safe-flight server 100 through the internet protocol based network 101) includes a method (e.g., using a processor communicatively coupled with a memory) through which a user (e.g., a user 126a) of the social network server may register an ownership interest in a real property (such as the building 114D of FIG. 1 illustrated in a form of a residential home by way of example). The user of the social network server may specify at least one of a permission, a restriction and a rule regarding a flight of the aerial vehicle in an airspace immediately above to the property (e.g., airspace above the building 114D) such that other users of the social network are any one of provided an access privilege and denied the access privilege to operate aerial devices in the airspace above the property. The permission, the restriction, and the rule may be entered into a safe-flight server database and associated with the airspace above the property. A flight-path generator algorithm may be applied to ensure at least one of the permission, the restriction, and the rule associated with the airspace above the property conforms to at least one of a rule and a regulation of a regulatory entity. The social network server may be associated with a geospatial social network. The social network server may verify the ownership interest of the user registering the ownership interest in the real property through a property ownership verification method.

FIG. 1 is a network view 150 showing a safe-flying route being generated by a safe-flight server and a flight path map, created based on the generation of the fast-flying route, being published through an Internet protocol based network to a plurality of searching users in a map-sharing community, according to one embodiment. In particular, FIG. 1 shows a safe-flight server 100, an Internet protocol based network 101 a memory 102, a processor 104, a database 106, a safe-flying route 108, an aerial vehicle 110, a position 112, a tree 114A, a utility pole 114B, a street light 114C, a building 144D, a utility line 114E, a traffic light 114F, a starting location 116, an ending location 118, a neighborhood area 120, a flight-path map 122, a set of flight paths 124, a plurality of searching users 126, a map-sharing community 128, and a safe-flying altitude 130.

The safe-flight server 100 may include the processor 104, the memory 102, and/or the database 106. The safe-flight server 100 may be one or more server side data processing systems (e.g., web servers operating in concert with each other) that operate in a manner that provide a set of instructions to any number of client side devices (e.g., a mobile device 502 and/or a computing device 602) communicatively coupled with the safe-flight server 100 through the Internet protocol based network 101. For example, the safe-flight server 100 may be a computing system (e.g., or a group of computing systems) that operates in a larger client-server database 106 framework (e.g., such as in a social networking software such as Nextdoor.com, Fatdoor.com, Facebook.com, etc.).

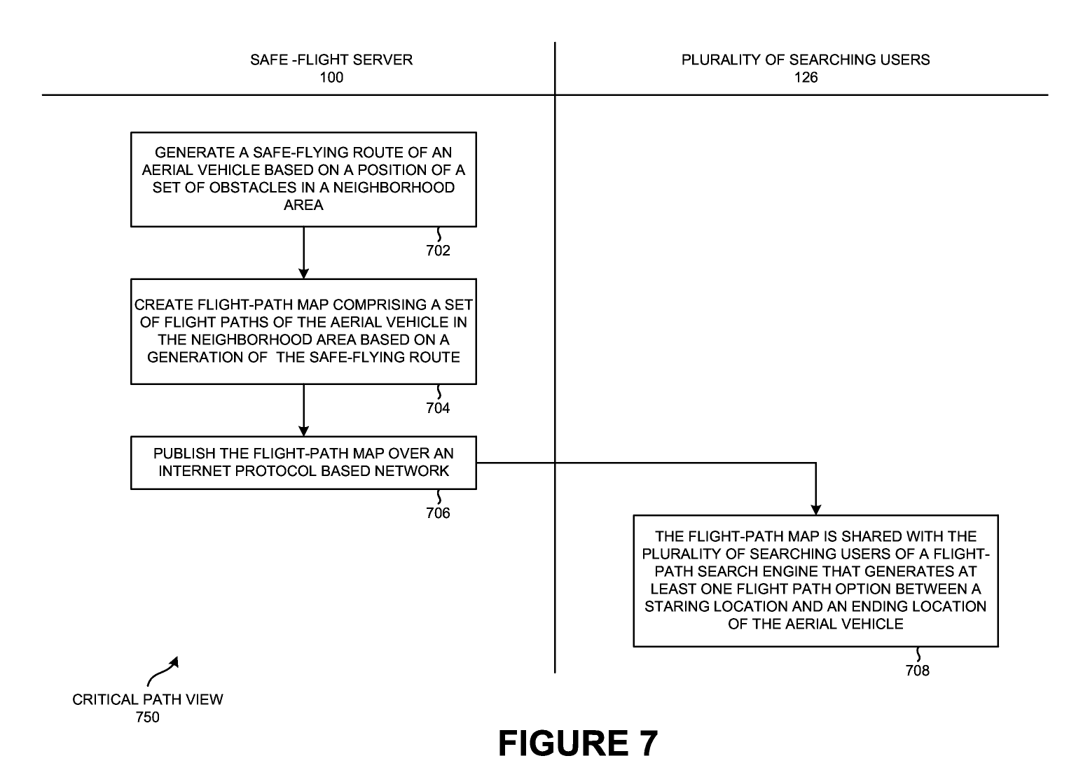

FIG. 1 illustrates a number of operations between the safe-flight server 100, the aerial vehicle 110, and the plurality of searching users 126. Particularly, circle ‘1’ of FIG. 1 illustrates the safe-flying route 108 being generated by the safe-flight server 100. In one embodiment, the safe-flying route 108 may be generated based on a search and/or a request of a searching user 400 of a flight-path search engine 606 (shown in FIG. 7). The safe-flying route 108 may be generated based on the position 112 of obstacles 114 (e.g., the tree 114A, the utility pole 114B, the street light 114C, the building 114D, the utility line 114E, and/or the traffic light 114F) in the neighborhood area 120.

In one embodiment, the position 112 of the obstacles 114 may be determined by aerial vehicles 110 (e.g., crowd sourced from aerial vehicles 110 operating in the neighborhood area 120), through government and/or city records, and/or through other data collection means (e.g., a data provider). The safe-flying route 108 may be the optimal route from the starting location 116 to the ending location 118 and/or may include multiple flight-paths 109 that traverse the obstacles 114 in the neighborhood area 120. The safe-flying route 108 may be generated based on past flight-paths 109 and/or feedback 304 provided by other aerial vehicles 110.

The safe-flying route 108 may be communicated from the safe-flight server 100, through the Internet protocol based network 101 (e.g., a wide area network), to the aerial vehicle 110. The aerial vehicle 110 may be a fully autonomous and/or semi-autonomous aerial vehicle and/or may be capable of transporting cargo and/or passengers. The safe-flying route 108 may be comprised of, but is in no way limited to, the geo-spatial location 404 (e.g., geo-spatial coordinates) of the starting location 116, the geo-spatial location 404 of the ending location 118, sensor data (e.g., data generated by a sensory fusion algorithm of the autonomous vehicle), a set of geo-spatial coordinates (e.g., waypoints), and/or altitude data.

The aerial vehicle 110 may be a helicopter, a multi rotor copter (e.g., a quadcopter and/or an octocpoter), and/or a fixed wing aerial vehicle 110. The safe-flying route 108 may need not be generated by the safe-flight server 100 and/or communicated to the aerial vehicle 110. In one embodiment, the aerial vehicle 110 may generate the safe-flying route 108 and/or communicate the safe-flying route 108 to the safe-flight server 100.

In the embodiment of FIG. 1, the safe-flight server 100 may use data from the aerial vehicle 110 and/or other aerial vehicle 110 to generate the safe-flying route 108. The safe-flight server 100 may use existing data (e.g., positions 112 of obstacles 114 and/or other planned flight-paths 109 in the neighborhood area 120) to generate the safe-flying route 108 and/or may incorporate new data (e.g., feedback 304) in real time as it is received.

Circle ‘2’ shows the flight-path map 122 being created based on the generation of the safe-flying route 108 and being published through the Internet protocol based network 101 to the plurality of searching users 126 in the map-sharing community 128. The flight-path map 122 may include the set of flight paths 124 and/or the safe-flying route 108 of the aerial vehicle 110 and/or all aerial vehicles 110 (e.g., all aerial vehicles 110 in the neighborhood area 120). The flight-path map 122 may be published such that it is accessible and/or searchable to searching users 400 in the map-sharing community 128 (e.g., Fatdoor.com). The flight-path 109 may be constantly updated, incorporating new information. The flight-path map 122 may enable the plurality of searching users 126 to request and/or generate flight-paths 109 (e.g., safe-flying route 108s) in the neighborhood area 120.

In one embodiment, the flight-path map 122 may be generated by the safe-flight server 100 using the processor 104, the memory 102, and/or the database 106. The flight-path map 122 may be communicated continuously and/or updated at certain intervals (e.g., when a threshold number of additions and/or updates have been made and/or at a determined time interval). The safe-flight server 100 may work in concert with the aerial vehicle 110 (e.g., adapting the flight-path map 122 to take into account information from the aerial vehicle 110 (e.g., obstacles 114 sensed, congestion 608 encountered, and/or new and/or additional data)). A GPS network and/or a cellular network (not shown) may be communicatively couple with the safe-flight server 100 and/or the aerial vehicle 110. The GPS network and/or the cellular network may provide data and/or enable the aerial vehicle 110 to operate and/or accurately generate and/or communicate data (e.g., feedback 304).

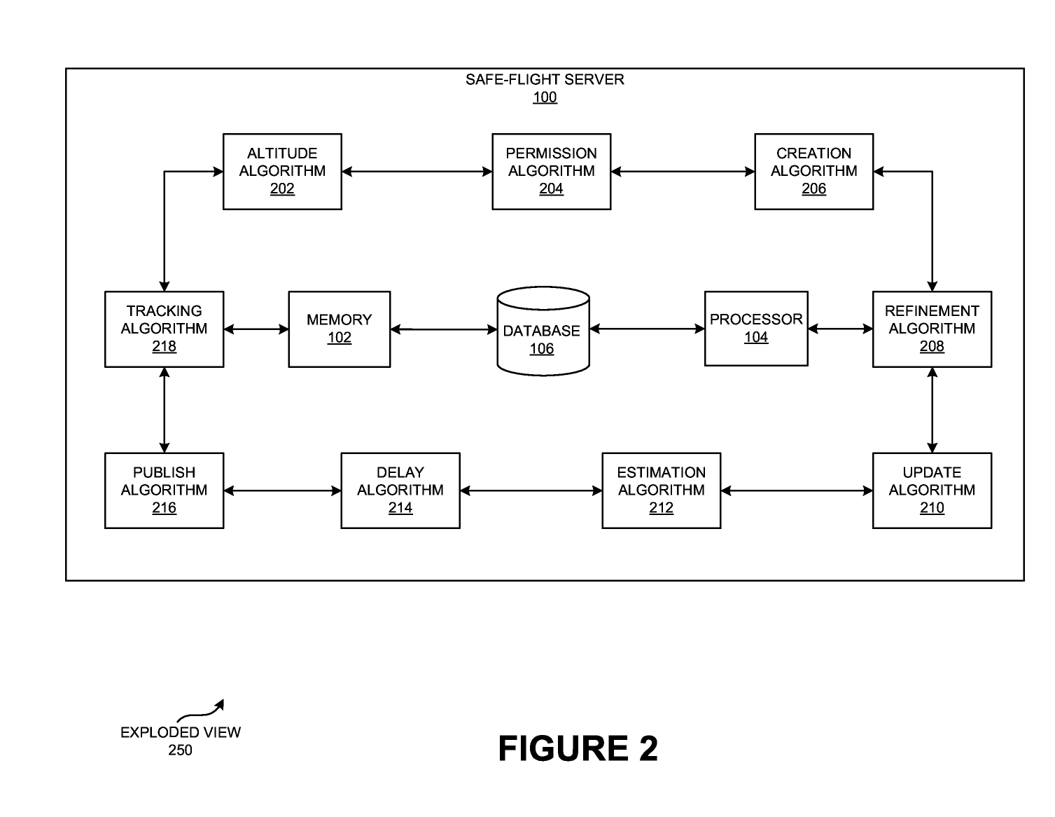

FIG. 2 is an exploded view 250 of the safe-flight server of FIG. 1, according to one embodiment. FIG. 2 shows an altitude algorithm 202, a permission algorithm 204, a creation algorithm 206, a refining algorithm 208, an update algorithm 210, an estimation algorithm 212, a delay algorithm 214, a publish algorithm 216, and a tracking algorithm 218.

In one embodiment, the altitude algorithm 202 may calculate the safe-flying altitude. The calculation may be made based on the position 112 of obstacles 114 (e.g., trees 114A, utility poles 114B, street lights 114C, buildings 114D, telephone lines, utility lines 114E, traffic lights 114F, and/or other aerial vehicles 110) in the neighborhood area 120. The safe-flying altitude 130 may be included in the safe-flying route 108 and/or may be comprised of a set of altitude points (e.g., an altitude the aerial vehicle 110 must reach when it arrives at a particular geo-spatial location 404 in the safe-flying route 108). In one embodiment, the geo-spatial coordinates may include the safe-flying altitude 130.

The permission algorithm 204 may permit aerial vehicles 110 to use the flight-path map 122 when planning flight paths in the neighborhood area 120. The flight-path map 122 may be communicated to the aerial vehicle 110 and/or stored on a memory 102 of the aerial vehicle 110. The creation algorithm 206 may create an initial flight path 302 (e.g., the safe-flying route 108) using a sensing technology (e.g., a sensor unit of the aerial vehicle 110). The sensing technology may detect obstacles 114 in the neighborhood area 120 between 0 and 200 feet above a ground 312. The safe-flying altitude 130 may be required to be at or below 200 feet above the ground 130. In one embodiment, the neighborhood area 120 may be an urban neighborhood setting, a rural setting, and/or a suburban neighborhood setting 310.

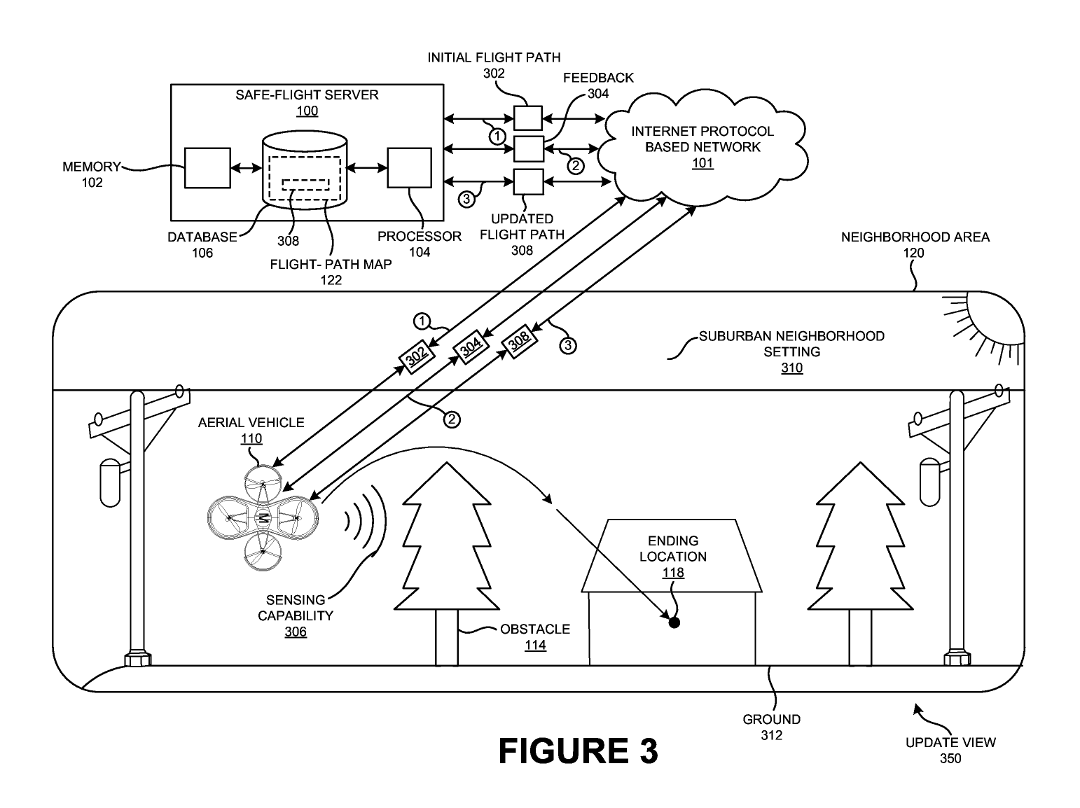

The refinement algorithm 208 may create an updated flight path 308 by refining the initial flight path 302 based on feedback 304. The feedback 304 may include information regarding sensed obstacles 114 and/or congestion 608 and/or may be communicated by aerial vehicles 110 in the neighborhood area 120 and/or aerial vehicles 110 traveling the initial flight path 302. The update algorithm 210 may update the flight-path map 122 based on the updated flight path 308. The creation of the updated flight path 308 and updating of the flight-path map 122 are further described in FIG. 3.

The delay algorithm 214 may determine a congestion 608 along a flight-path 109 (e.g., the safe-flying route 108). The delay algorithm 214 may work in concert with the sensing technology of the aerial vehicle 110 and/or may use feedback 304 received from aerial vehicles 110. The estimation algorithm 212 may calculate an estimated flight time 406 from the starting location 116 to the ending location 118. The estimation algorithm 212 may work in concert with the delay algorithm 214 to update the estimated flight time 406 based on detected congestion 608 and/or obstacles 114.

The publish algorithm 216 may publish the flight-path map 122 through a computing device 602 and/or a mobile device 502 to the plurality of searching users 126 of the map-sharing community 128. The publish algorithm 216 may make the flight-path map 122 available to the plurality of searching users 126 and/or aerial vehicle 110. The published flight-path map 122 may be updated constantly and/or may be published (e.g., as an updated flight-path map 122) at certain intervals. The tracking algorithm 218 may enable the plurality of searching users 126 to track the aerial vehicle 110 as it travels from the starting location 116 to the ending location 118. The at least one searching user 400 may be able to view the progress of the aerial vehicle 110 through a map view 504 (e.g., a view of the flight-path map 122) of the computing device 602 and/or the mobile device 502.

FIG. 3 is an update view 350 of an initial flight path being updated based on a feedback communicated from the autonomous vehicle to the safe-flight server of FIG. 1, according to one embodiment. Particularly, FIG. 3 illustrates an initial flight path 302, a feedback 304, a sensing capability 306, an updated flight path 308, a suburban neighborhood setting 310, and a ground 312.

Circle ‘1’ shows the safe-flight server 100 communicating the initial flight path 302, through the Internet protocol based network 101, to the aerial vehicle 110. The initial flight path 302 may be a route (e.g., the safe-flying route 108) generated by the safe-flight server 100 to guide the aerial vehicle 110 the starting location 116 to the ending location 118. The initial flight path 302 may be a set of instructions (e.g., navigation data) that guides the aerial vehicle 110. In the example embodiment of FIG. 3, the sensing capability 306 of the aerial vehicle 110 may sense the obstacle 114 (e.g., the tree) along the initial flight path 302. The aerial vehicle 110 may have a sensing technology (e.g., a sensor) that may enable the sensing capability 306. The sensing technology may include an ultrasound sensor, a radio frequency sensor, a laser sensor, a radar sensor, an optical sensor, a stereo optical sensor, and a LIDAR sensor, and/or a mixed signal sensor. The sensor may comprise multiple sensors working in concert.

In Circle ‘2,’ the aerial vehicle 110 sends the feedback 304 to the safe-flight server 100. The feedback 304 may be triggered when the aerial vehicle 110 determines (e.g., using the sensing capability 306 and/or the sensory fusion algorithm) that the obstacle 114 impedes the initial flight path 302, represents a relevant change to the flight-path map 122 and/or initial flight path 302 (e.g., a permanent obstruction, a large obstacle 114 (e.g., one that requires deviation from the initial flight path 302 to traverse), and/or a dangerous obstacle 114 (e.g., one that may damage the aerial vehicle 110, property, and/or pedestrians)). In one embodiment, all data gathered by aerial vehicles 110 operating in the neighborhood area 120 (e.g., sensor data) may be sent to the safe-flight server 100. The feedback 304 may only be communicated if it contains new data (e.g., information not present in the flight-path map 122, the database 106 and/or the memory 102 of the safe-flight server 100 and/or aerial vehicle 110).

The safe-flight server 100 may use the feedback 304 to update the flight-path map 122 of the neighborhood community (e.g., enabling the plurality of searching users 126 to learn of dangerous obstructions in their neighborhood area 120 and/or learn of changes to the flight-path(s) 109 between the starting location 116 and the ending location 118) and/or the initial flight-path 109. In Circle ‘3,’ the updated flight path 308 is sent from the safe-flight server 100 to the aerial vehicle 110. The updated flight path 308 may be a new flight-path 109 and/or the initial flight path 302 with information added and/or removed. The updated flight path 308 may route the aerial vehicle 110 while taking into account the flight-paths 109 of other aerial vehicles 110 in the neighborhood area 120, additional sensed obstacles 114 (e.g., the initial flight path 302 may by updated based on feedback 304 of other aerial vehicles 110 while a particular aerial vehicle is traversing the initial flight path 302). In one embodiment, the updated flight path 308 may route the aerial vehicle 110 along a new path (e.g., in the case that the obstacle 114 and/or congestion 608 renders the initial flight path 302 suboptimal and/or impassable). The aerial vehicle 110 may not be required to wait for the updated flight path 308. The aerial vehicle 110 may be able to traverse the obstacle 114 on its own and/or continue along the initial flight path 302. The updated flight path 308 may be communicated to other aerial vehicles 110 that are and/or will be traversing the initial flight path 302.

In one embodiment, aerial vehicles 110 operating in the neighborhood area 120 may be able to communicate with each other through ad-hoc local networks. These peer to peer communications may enable aerial vehicles 110 to update flight-paths 109 and/or flight-path map 122s based on feedback 304 from other aerial vehicles 110 without need of communication with the safe-flight server 100. These peer-to-peer communications may enable aerial vehicles 110 to operate and/or update flight-paths 109 and/or flight-path map 122s in areas with poor or non-existent connectivity with the safe-flight server 100.

In one embodiment, the flight-path map 122 may be stored in the aerial vehicles 110. The aerial vehicles 110 may be able to apply feedback 304 to the flight-path map 122 and/or update flight-paths 109 internally and/or communicate changes and/or updates to the safe-flight server 100 at regular intervals and/or certain times (e.g., when an obstacle 114 is sensed that is deemed worthy of updating and/or when the aerial vehicle 110 regains central communication to the safe-flight server 100). In one embodiment, minor obstructions (e.g., non-permanent obstacles 114) and/or minor congestion 608 may be communicated via the ad-hoc local network to other aerial vehicles 110 but not the safe-flight server 100.

The feedback 304 may be used to update the flight-path map 122. The updated flight-path 109 may be stored in the database 106 and/or may replace the initial flight path 302 in the database 106 and/or flight-path map 122. The flight-path map 122 (e.g., the updated flight-path map) may be published to the plurality of searching users 126 of the map-sharing community 128 in real time (e.g., as the flight-path map 122 is updated) and/or at certain intervals (e.g., when a threshold number of updates have occurred and/or at set time intervals). The updated flight-path map 122 may be communicated when a searching user 400 requests a flight-path 109 that has been impacted by an update to the flight-path 109 (e.g., the initial flight path 302).

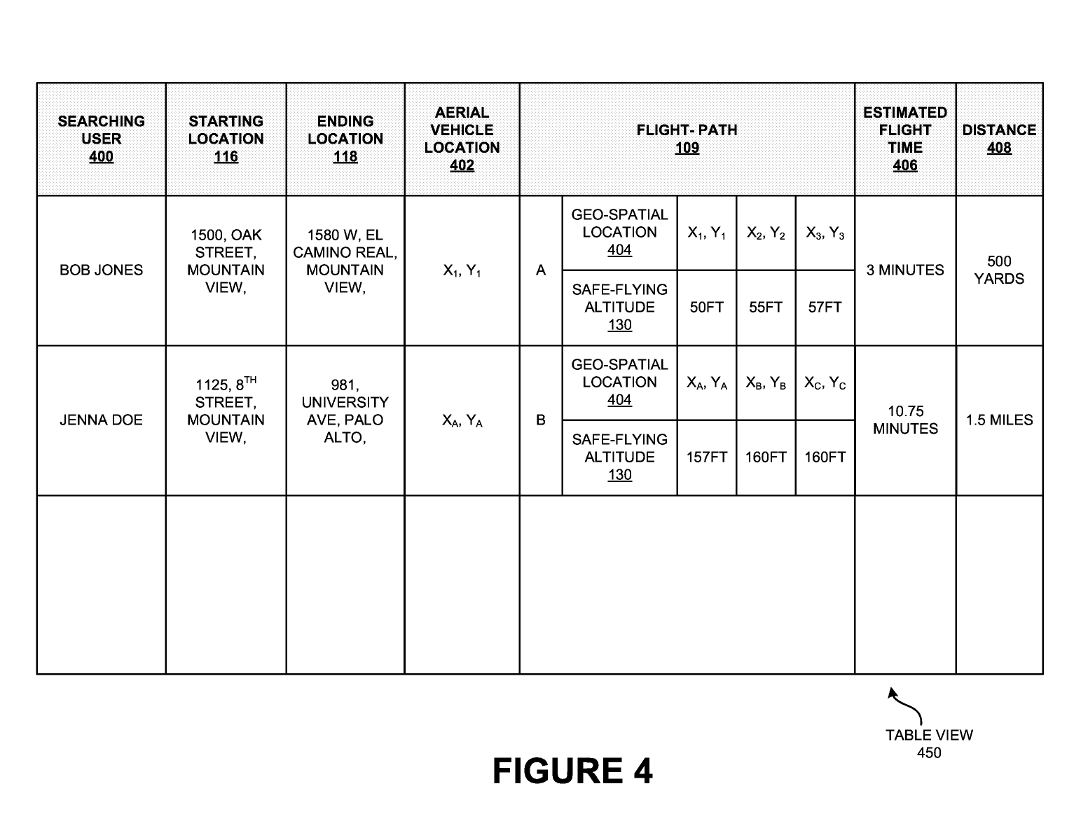

FIG. 4 is a table view 450 illustrating the data relationships between the plurality of searching users, the aerial vehicle, and the flight-path, according to one embodiment. FIG. 4 shows a searching user 400, an aerial vehicle location 402, a geo-spatial location 404, an estimated flight time 406, and a distance 408.

The searching user 400 may be a user of the flight-path search engine 606. The starting location 116 and/or the ending location 118 may be a set of geo-spatial coordinates, an address, and/or a name of a location (e.g., a business name and/or place name). In one embodiment. The starting location 116 and/or ending location 118 may need to be located in the neighborhood area 120. The aerial vehicle location 402 may be the location (e.g., geo-spatial coordinates) of the aerial vehicle 110 intended to execute the safe-flying route 108 when the searching user 400 searches for a route and/or instructs (e.g., using the computing device 602 and/or the mobile device 502) the aerial vehicle 110 to begin traveling along the safe-flying route 108. The aerial vehicle location 402 may be updated to reflect the current geo-spatial location 404 of the aerial vehicle 110 as it traverses the neighborhood area 120.

The flight-path 109 may be the safe-flying route 108. The searching user 400 may be presented with multiple flight-paths 109 from the starting location 116 to the ending location 118 from which to choose. The flight-path 109 may include geo-spatial locations 404 (e.g., waypoints and/or geo-spatial coordinates) and/or safe-flying altitudes. In one embodiment, the safe-flying altitude 130 may be part of the geo-spatial location 404.

The distance 408 may be the amount of space between the starting location 116 and the ending location 118 that the flight-path 109 requires the aerial vehicle 110 to navigate. The estimated flight time 406 may be the calculated amount of time the flight-path 109 will take to traverse. The estimated flight time 406 may be generated based on the distance 408, speed of the aerial vehicle 110 (e.g., a set speed and/or an average speed), and/or the congestion 608 detected and/or expected along the flight-path 109. In one embodiment, the estimated flight time 406 may be updated as the aerial vehicle 110 travels along the flight-path 109.

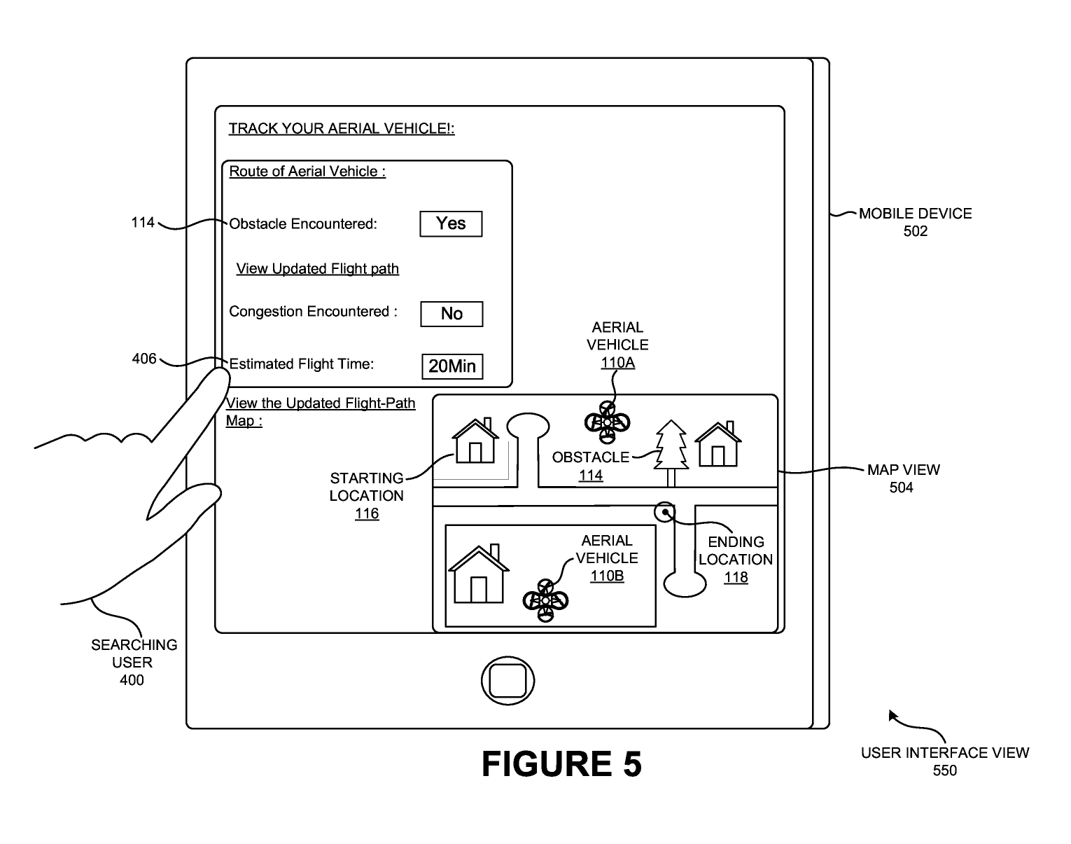

FIG. 5 is a user interface view 550 of a mobile device of a searching user displaying a map view, according to one embodiment. FIG. 5 shows a mobile device 502 and a map view 504.

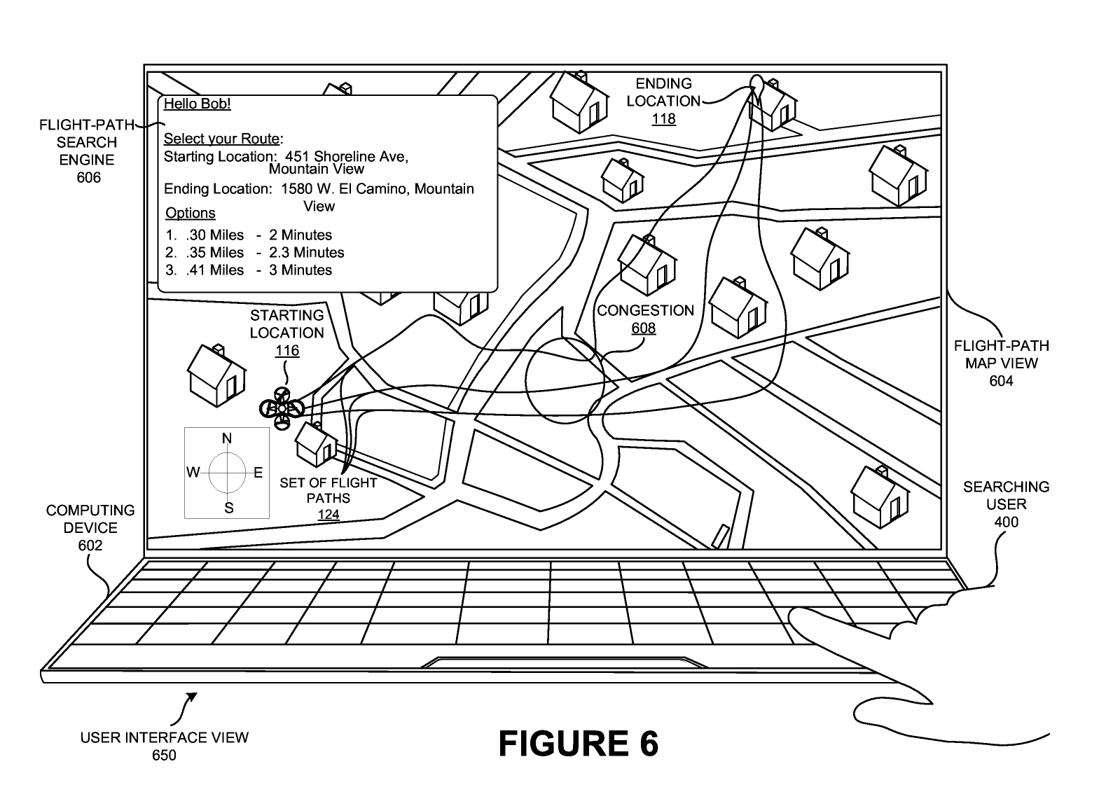

The flight-path map 122 may be published through the mobile device 502 and/or computing device 602 associated with the searching user 400. The mobile device 502 (e.g., a smartphone, a tablet, and/or a portable data processing system) may access the map-sharing community 128 through the Internet protocol based network 101 using a browser application of the mobile device 502 (e.g., Google®, Chrome) and/or through a client-side application downloaded to the mobile device 502 (e.g., a Nextdoor.com mobile application, a Fatdoor.com mobile application) operated by the searching user 400. In an alternate embodiment, a computing device 602 (e.g., the computing device 602 of FIG. 6) may access the map-sharing community 128 through the Internet protocol based network 101.

The searching user 400 may be able to receive and/or view updates about the aerial vehicle 110 (e.g., the aerial vehicle 110A) traversing the flight-path 109. The mobile device 502 may enable the searching user 400 to view a status of the aerial vehicle 110 (e.g., remaining power and/or operational statuses). The searching user 400 may be able to view if obstacles 114 have been encountered, what the obstacles 114 are, where they were encountered, and/or view pictures and/or video captured by the aerial vehicle 110. The searching user 400 may able to view if congestion 608 was encountered, where it was encountered, and/or the nature of the congestion 608. In one embodiment, the searching user 400 may be informed if the aerial vehicle 110 (e.g., the aerial vehicle 110A) receives the updated flight path 308. The searching user 400 may only be notified of the updated flight path 308 if the aerial vehicle 110 must alter its original path (e.g., the updated flight path 308 is substantially different from the initial flight path 302 (e.g., if the estimated flight time 406 has changed and/or if the distance 408 has changed). The estimated flight time 406 may be an estimated total time it will take to travel the flight-path 109. The estimated flight time 406 may be the time left to reach the ending location 118 (e.g., time until destination) and/or the time that has elapsed since leaving the starting location 116.

The map view 504 may be a representation of the flight-path map 122. The map view 504 may show a satellite map, a geometric map, a ground-level view, an aerial view, a three-dimensional view, and/or another type of map view 504. The map view 504 may enable the searching user 400 to track the aerial vehicle 110 as it traverses the flight-path 109. In one embodiment, the searching user 400 may be able to view a video captured by a camera of the aerial vehicle 110. The searching user 400 may be able to switch between the camera view and the map view 504. In one embodiment, the map view 504 may enable the searching user 400 to see areas of congestion 608, obstacles 114, and/or other aerial vehicles 110 operating in the neighborhood area 120 (e.g., the aerial vehicle 110B and/or other aerial vehicles 110 traveling along the safe-flying route 108 and/or flight-paths 109 that intersect with the safe-flying route 108). In one embodiment, the searching user 400 may be able to select (e.g., approve) an alternate flight-path 109 using the mobile device 502.

FIG. 6 is a user interface view 650 of the searching user of FIG. 5 selecting a flight-path on a computing device using a flight-path search engine, according to one embodiment. In particular, FIG. 6 shows a computing device 602, a flight-path map view 604, a flight-path search engine 606, and a congestion 608.

In one embodiment, searching users 400 of the map-sharing community 128 may be able to generate flight-paths 109 from the starting location 116 to the ending location 118. The searching user 400 may be presented with multiple options (e.g., multiple initial flight-paths 109 and/or safe-flying routes 108) from which to choose. The searching user 400 may be able to view the multiple flight-paths 109 on the flight-path map view 604. The searching user 400 may be able to view listed flight-paths (e.g., flight-paths 109 stored on the database 106 and/or on the flight-path map 122) through the flight-path map view 604.

The searching user 400 may be able to see high congestion areas along the flight-path(s) 109, obstacles 114 (e.g., obstacles 114 detected and/or communicated as feedback 304 by aerial vehicles 110), and/or be able to track the aerial vehicle's 110 progress along the flight-path 109 using the flight-path map view 604 on their computing device 602. The searching user 400 may be able to filter results based on the distance 408 of the flight-path 109, the estimated flight time 406, a preference etc.

FIG. 7 is a critical path view 750 illustrating a flow based on time in which critical operations of the safe flight-path search engine of FIG. 1 occur, according to one embodiment. In operation 702, the safe-flight server 100 may generate a safe-flying route 108 of an aerial vehicle 110 based on a position 112 of a set of obstacles 114 (e.g., a tree 114A, a utility pole 114B, a street light 114C, a building 114D, a telephone line, a utility line 114E, and/or a traffic light 114F) in a neighborhood area 120. A flight-path map 122 may be created comprising a set of flight-paths 109 of the aerial vehicle 110 in the neighborhood area 120 based on the generation of the safe-fling route in operation 704. In operation 706, the safe-flight server 100 may publish the flight-path map 122 over an Internet protocol based network 101. The fight-path map 122 may be shared with the plurality of searching users 126 of a flight-path search engine 606 that generates at least one flight path option between a starting occasion and an ending location 118 of the aerial vehicle 110 in operation 708.

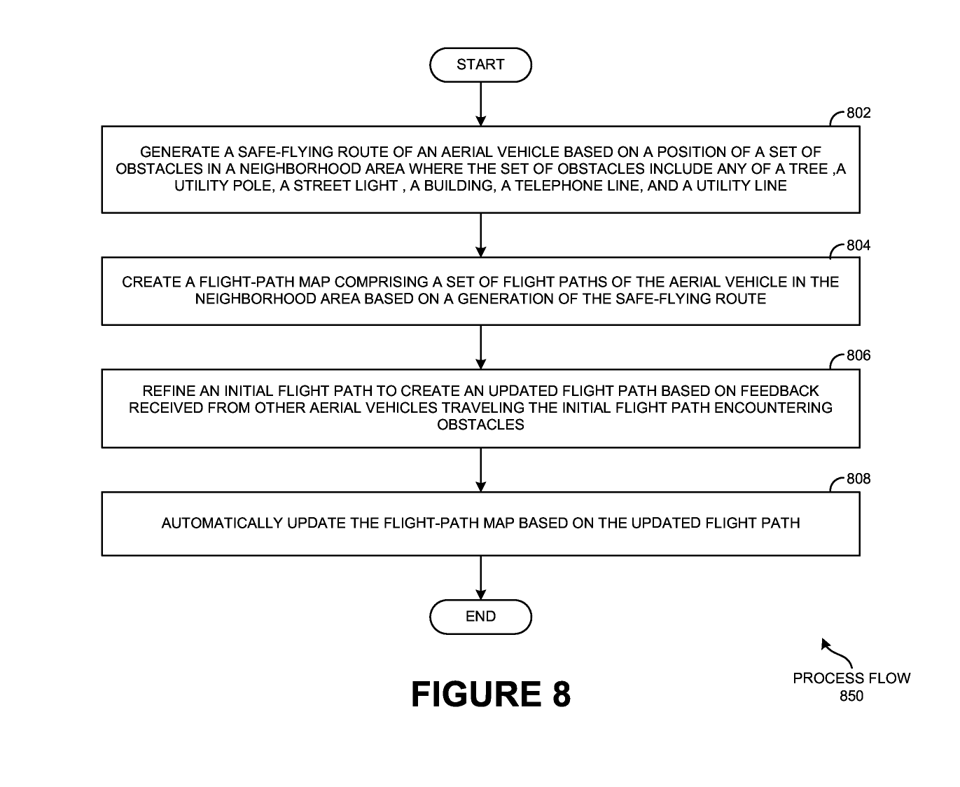

FIG. 8 is a process flow 850 of the safe flight-path search engine of FIG. 7, according to one embodiment. Particularly, operation 802 may generate a safe-flying route 108 of an aerial vehicle 110 based on a position 112 of a set of obstacles 114 in a neighborhood area 120, where the set of obstacles 114 include a tree 114A, a utility pole 114B, a street light 114C, a building 114D, a telephone line, and/or a utility line 114E. A flight-path map 122 may be created comprising a set of flight paths 124 of the aerial vehicle 110 in the neighborhood area 120 based on a generation of the safe-flying route 108 in operation 804. An initial flight path 302 may be refined to create an updated flight path 308 based on feedback 304 received from other aerial vehicles 110 traveling the initial flight path 302 encountering obstacles 114 in operation 806. Operation 808 may automatically update the flight-path map 122 based on the updated flight path 308.

Disclosed are a method and system of a safe flight-path search engine, according to one embodiment. In one embodiment, a method of a safe-flight server 100 includes generating a safe-flying route 108 of an aerial vehicle 110 based on a position 112 of a set of obstacles 114 in a neighborhood area 120, creating a flight-path map 122 comprising a set of flight paths 124 of the aerial vehicle 110 in the neighborhood area 120 based on the generation of the safe-flying route 108, and publishing the flight-path map 122 over an Internet protocol based network 101 (such that the flight-path map 122 is sharable with a plurality of searching users 126 of a flight-path search engine 606 that generates at least one flight path option between a starting location 116 and an ending location 118 of the aerial vehicle 110). The set of obstacles 114 includes any of a tree 114A, a utility pole 114B, a street light 114C, a building 114D, a telephone line, and a utility line 114E.

A safe-flying altitude 130 of the aerial vehicle 110 may be calculated based on the position 112 of an obstacle 114 (e.g., the tree 114A, the utility pole 114B, the street light 114C, the building 114D, the telephone line, and/or the utility line 114E) in the neighborhood area 120. Aerial vehicles 110 may be permitted to utilize the flight-path map 122 when planning flight-paths 109 in the neighborhood area 120. An initial flight path 302 may be created based on a sensing technology to detect obstacles 114 in a region between 0 feet and 200 feet above a ground in the neighborhood area 120. The neighborhood area 120 may be an urban neighborhood setting, a rural setting, and/or a suburban neighborhood setting 310.

The initial flight path 302 may be refined to create an updated flight path 308 based on feedback 304 received from other aerial vehicles 110 traveling the initial flight path 302 encountering obstacles 114. The flight-path map 122 may be automatically updated based on the updated flight path 308. An estimated flight time 406 may be calculated from the starting location 116 to the ending location 118 of the aerial vehicle 110 requesting to traverse locations on the flight-path map 122.

A congestion 608 between the starting location 116 and the ending location 118 may be determined based on the feedback 304 received from aerial vehicles 110 traveling the initial flight path 302 encountering delays. A set of encountered obstacles 114 and/or encountered delays may be determined based on at least one sensor of a traversing aerial vehicle 110. The at least one sensor may include an ultrasound sensor, a radio frequency sensor, a laser sensor, a radar sensor, an optical sensor, a stereo optical sensor, and/or a LIDAR sensor. The flight-path map 122 may be published through a computing device 602 and/or a mobile device 502 to the plurality of searching users 126 of a map-sharing community 128. The plurality of searching users 126 may be permitted to track the traversing aerial vehicle 110 while in flight through a map view 504 of the computing device 602 and/or the mobile device 502.

In another embodiment, a method of a safe-flight server 100 includes generating a safe-flying route 108 of an aerial vehicle 110 based on a position 112 of a set of obstacles 114 in a neighborhood area 120, creating a flight-path map 122 comprising a set of flight paths 124 of the aerial vehicle 110 in the neighborhood area 120 based on the generation of the safe-flying route 108, refining an initial flight path 302 to create an updated flight path 308 based on feedback 304 received from other aerial vehicles 110 traveling the initial flight path 302 encountering obstacles 114, and automatically updating the flight-path map 122 based on the updated flight path 308. The set of obstacles 114 includes any of a tree 114A, a utility pole 114B, a street light 114C, a building 114D, a telephone line, and a utility line 114E. The method may publish the flight-path map 122 over an Internet protocol based network 101 in a manner such that the flight-path map 122 is sharable with users of a flight-path search engine 606 that generates at least one flight path option between a starting location 116 and an ending location 118 of the aerial vehicle 110.

In yet another embodiment, a system includes an aerial vehicle 110, an Internet protocol based network 101, and a safe-flight server 100 to generate a safe-flying route 108 of the aerial vehicle 110 based on a position 112 of a set of obstacles 114 in a neighborhood area 120, create a flight-path map 122 comprising a set of flight paths 124 of the aerial vehicle 110 in the neighborhood area 120 based on the generation of the safe-flying route 108, and publish the flight-path map 122 over the Internet protocol based network 101 in a manner such that the flight-path map 122 is sharable with a plurality of searching users 126 of a flight-path search engine 606 that generates at least one flight path option between a starting location 116 and an ending location 118 of the aerial vehicle 110. The set of obstacles 114 includes any of a tree 114A, a utility pole 114B, a street light 114C, a building 114D, a telephone line, and a utility line 114E.

An altitude algorithm 202 may calculate a safe-flying altitude 130 of the aerial vehicle 110 based on the position 112 of an obstacle 114 (e.g., the tree 114A, the utility pole 114B, the street light 114C, the building 114D, the telephone line, and/or the utility line 114E) in the neighborhood area 120. A permission algorithm 204 may permit aerial vehicles 110 to utilize the flight-path map 122 when planning flight paths in the neighborhood area 120. A creation algorithm 206 may create an initial flight path 302 based on a sensing technology to detect obstacles 114 in a region between 0 feet and 200 feet above a ground in the neighborhood area 120. The neighborhood area 120 may be in an urban neighborhood setting, a rural setting, and/or a suburban neighborhood setting 310.

A refinement algorithm may refine the initial flight path 302 to create an updated flight path 308 based on feedback 304 received from other aerial vehicles 110 traveling the initial flight path 302 encountering obstacles 114. An update algorithm 210 may automatically update the flight-path map 122 based on the updated flight path 308. An estimation algorithm 212 may calculate an estimated flight time 406 from the starting location 116 to the ending location 118 of the aerial vehicle 110 requesting to traverse locations on the flight-path map 122.

A delay algorithm 214 may determine a congestion 608 between the starting location 116 and the ending location 118 based on the feedback 304 received from aerial vehicles 110 traveling the initial flight path 302 encountering delays. A set of encountered obstacles and/or encountered delays may be determined based on at least one sensor of a traversing aerial vehicle 110. The at least one sensor mat include an ultrasound sensor, a radio frequency sensor, a laser sensor, a radar sensor, an optical sensor, a stereo optical sensor, and/or a LIDAR sensor . A publish algorithm 216 may publish the flight-path map 122 through a computing device 602 and/or a mobile device 502 to the plurality of searching users 126 of a map-sharing community 128. A tracking algorithm 218 may permit the plurality of searching users 126 to track the traversing aerial vehicle 110 while in flight through a map view 504 of the computing device 602 and/or the mobile device 502.

An example embodiment will now be described. In one example embodiment, Joe may enjoy flying his aerial vehicle 110 in his neighborhood area 120 and/or may wish to use his aerial vehicle 110 to complete tasks (e.g., make deliveries and/or pickups in the neighborhood area 120). Joe may not want to construct flight-paths 109 for every flight and/or may not have a complete knowledge of the conditions of the air space in his neighborhood area 120.

Joe may hear of the safe flight-path search engine and become a user. Joe may be able to view and/or contribute to the flight-path map 122 of the neighborhood area 120. He may search for established (e.g., pre-planned and/or pre-flown) flight-paths 109 and/or safe-fling routes 108 using the flight-map search engine 606. In one embodiment, Joe may be able to select from multiple flight-paths 109 from his desired starting location 116 and ending location 118. By using the safe flight-path search engine, Joe may be able to quickly and easily set a flight-path 109 for his aerial vehicle 110 by using existing information and/or resources.

In one embodiment, Joe may create a new flight-path from a starting location to an ending location. The route may not have been queried and/or flown using the safe-flight server 100 prior to Joe's aerial vehicle's flight. Joe's flight-path 109 may be added to the flight-path map 122 and/or published to other searching users 400. Feedback from Joe's aerial vehicle may be included in the flight-path map 122, creating an updated flight-path map. For example, the feedback may include a new altitude of a growing tree in the neighborhood area 1200.

In another embodiment, a user of a neighborhood social network may indicate “safe fly zones”. For example, the user may indicate that it is acceptable or not acceptable to fly within and/or through a spatial location immediately adjacent to their property or near their property over their plot of land using a map view, by indicating their address, and/or claiming their address/profile on the social network. The user may draw a polygon and/or select their plot of land and verify that they actually live, own, lease, and/or otherwise control rights to that land using the various embodiments described herein. After doing so, the user may be able to tell the neighborhood (and/or geospatial social network) that it is acceptable and/or not acceptable to fly over their plot of land, within a certain distance of their windows, among other spatial locations immediately adjacent to their properties. The user may be able to designate access privileges for rules that govern their plot of land, and how it is to be managed and/or administered (e.g., flying inside an airspace where inside view of their home is possible could be allowed only at faster speeds where personal privacy is safe guarded by the fact no meaningful still or moving image can be recorded at higher speeds). Once users have set their permissions and/or access rights to their respective plots of land, robotic and aeronautic devices of a neighborhood social network may be able to “permit” or “deny” whether users can fly over a given plot of land and re-route vehicles connected to the safe-flying network as necessary to ensure protection of private property rights and privacy protection. Moreover, on top of the social network user preferences, which allow for granting permission and/or denials relating to use of airspace immediately adjacent to privately owned or leased property, are the federal, state, county and city rules and regulations on airspace use (e.g. Federal Aviation Administration). The safe flight-path search engine would ensure that aforementioned rules and regulations are enforced before and after accounting for social network user preferences to the extent allowed by hardware, software and communications.

In one embodiment, a social network server (e.g., the social network server may embedded in the safe flight server 100, and/or may be separate from it and communicatively coupled with the safe-flight server 100 through the internet protocol based network 101) includes a method (e.g., using a processor communicatively coupled with a memory) through which a user (e.g., a user 126a) of the social network server may register an ownership interest in a real property (such as the building 114D of FIG. 1 illustrated in a form of a residential home by way of example). The user of the social network server may specify at least one of a permission, a restriction and a rule regarding a flight of the aerial vehicle in an airspace immediately above to the property (e.g., airspace above the building 114D) such that other users of the social network are any one of provided an access privilege and denied the access privilege to operate aerial devices in the airspace above the property. The permission, the restriction, and the rule may be entered into a safe-flight server database and associated with the airspace above the property. A flight-path generator algorithm may be applied to ensure at least one of the permission, the restriction, and the rule associated with the airspace above the property conforms to at least one of a rule and a regulation of a regulatory entity. The social network server may be associated with a geospatial social network. The social network server may verify the ownership interest of the user registering the ownership interest in the real property through a property ownership verification method.

Although the present embodiments have been described with reference to specific example embodiments, it will be evident that various modifications and changes may be made to these embodiments without departing from the broader spirit and scope of the various embodiments. For example, the various devices, algorithms, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a safe-flight server, comprising:
generating a safe-flying route of an aerial vehicle based on a position of a set of obstacles in a neighborhood area, wherein the set of obstacles include any of a tree, a utility pole, a street light, a building, a telephone line, and a utility line;
creating a flight-path map comprising a set of flight paths of the aerial vehicle in the neighborhood area based on the generation of the safe-flying route; and
publishing the flight-path map over an Internet protocol based network in a manner such that the flight-path map is sharable with a plurality of searching users of a flight-path search engine that generates at least one flight path option between a starting location and an ending location of the aerial vehicle.

2. The method of claim 1 further comprising:
calculating a safe-flying altitude of the aerial vehicle based on the position of an obstacle in the neighborhood area, wherein the obstacle includes any one of the tree, the utility pole, the street light, the building, the telephone line, and the utility line.

3. The method of claim 2 further comprising:
permitting aerial vehicles to utilize the flight-path map when planning flight paths in the neighborhood area; and
creating an initial flight path based on a sensing technology to detect obstacles in a region between 0 feet and 200 feet above a ground in the neighborhood area, wherein the neighborhood area is in at least one of an urban neighborhood setting, a rural setting, and a suburban neighborhood setting.

4. The method of claim 3 further comprising:
refining the initial flight path to create an updated flight path based on feedback received from other aerial vehicles traveling the initial flight path encountering obstacles; and
automatically updating the flight-path map based on the updated flight path.

5. The method of claim 4 further comprising:
calculating an estimated flight time from the starting location to the ending location of the aerial vehicle requesting to traverse locations on the flight-path map.

6. The method of claim 5 further comprising:
determining a congestion between the starting location and the ending location based on the feedback received from aerial vehicles traveling the initial flight path encountering delays,
wherein a set of encountered obstacles and encountered delays are determined based on at least one sensor of a traversing aerial vehicle, comprising any of an ultrasound sensor, a radio frequency sensor, a laser sensor, a radar sensor, an optical sensor, a stereo optical sensor, and a LIDAR sensor
wherein encountered delays could also be determined by the feedback provided by other aerial vehicles to the safe-flight planning server

7. The method of claim 6 further comprising:
publishing the flight-path map through at least one of a computing device and a mobile device to the plurality of searching users of a map-sharing community; and
permitting at least one of the plurality of searching users to track the traversing aerial vehicle while in flight through a map view of at least one of the computing device and the mobile device.

8. A method of a safe-flight server, comprising:
generating a safe-flying route of an aerial vehicle based on a position of a set of obstacles in a neighborhood area, wherein the set of obstacles include any of a tree, a utility pole, a street light, a building, a telephone line, and a utility line;
creating a flight-path map comprising a set of flight paths of the aerial vehicle in the neighborhood area based on the generation of the safe-flying route;
refining an initial flight path to create an updated flight path based on feedback received from other aerial vehicles traveling the initial flight path encountering obstacles; and
automatically updating the flight-path map based on the updated flight path.

9. The method of claim 8 further comprising:
publishing the flight-path map over an Internet protocol based network in a manner such that the flight-path map is sharable with users of a flight-path search engine that generates at least one flight path option between a starting location and an ending location of the aerial vehicle.

10. The method of claim 9 further comprising:
calculating a safe-flying altitude of the aerial vehicle based on the position of an obstacle in the neighborhood area, wherein the obstacle includes any one of the tree, the utility pole, the street light, the building, the telephone line, and the utility line.

11. The method of claim 10 further comprising:
permitting aerial vehicles to utilize the flight-path map when planning flight paths in the neighborhood area; and
creating the initial flight path based on a sensing technology to detect obstacles in a region between 0 feet and 200 feet above a ground in the neighborhood area, wherein the neighborhood area is in at least one of an urban neighborhood setting, a rural setting, and a suburban neighborhood setting.

12. The method of claim 11 further comprising:
calculating an estimated flight time from the starting location to the ending location of the aerial vehicle requesting to traverse locations on the flight-path map.

13. The method of claim 12 further comprising:
determining a congestion between the starting location and the ending location based on the feedback received from aerial vehicles traveling the initial flight path encountering delays,
wherein a set of encountered obstacles and encountered delays are determined based on at least one sensor of a traversing aerial vehicle, comprising any of an ultrasound sensor, a radio frequency sensor, a laser sensor, a radar sensor, an optical sensor, a stereo optical sensor, and a LIDAR sensor.

14. The method of claim 13 further comprising:
publishing the flight-path map through at least one of a computing device and a mobile device to a plurality of searching users of a map-sharing community; and
permitting at least one of the plurality of searching users to track the traversing aerial vehicle while in flight through a map view of at least one of the computing device and the mobile device.

15. A system, comprising:
an aerial vehicle;
an Internet protocol based network; and
a safe-flight server:
to generate a safe-flying route of the aerial vehicle based on a position of a set of obstacles in a neighborhood area, wherein the set of obstacles include any of a tree, a utility pole, a street light, a building, a telephone line, and a utility line,
to create a flight-path map comprising a set of flight paths of the aerial vehicle in the neighborhood area based on the generation of the safe-flying route, and
to publish the flight-path map over the Internet protocol based network in a manner such that the flight-path map is sharable with a plurality of searching users of a flight-path search engine that generates at least one flight path option between a starting location and an ending location of the aerial vehicle.

16. The system of claim 15 further comprising:
an altitude algorithm to calculate a safe-flying altitude of the aerial vehicle based on the position of an obstacle in the neighborhood area, wherein the obstacle includes any one of the tree, the utility pole, the street light, the building, the telephone line, and the utility line.

17. The system of claim 16 further comprising:
a permission algorithm to permit aerial vehicles to utilize the flight-path map when planning flight paths in the neighborhood area; and
a creation algorithm to create an initial flight path based on a sensing technology to detect obstacles in a region between 0 feet and 200 feet above a ground in the neighborhood area, wherein the neighborhood area is in at least one of an urban neighborhood setting, a rural setting, and a suburban neighborhood setting.

18. The system of claim 17 further comprising at least one of:
a refinement algorithm to refine the initial flight path to create an updated flight path based on feedback received from other aerial vehicles traveling the initial flight path encountering obstacles;
an update algorithm to automatically update the flight-path map based on the updated flight path; and
an estimation algorithm to calculate an estimated flight time from the starting location to the ending location of the aerial vehicle requesting to traverse locations on the flight-path map.

19. The system of claim 18 further comprising:
a delay algorithm to determine a congestion between the starting location and the ending location based on the feedback received from aerial vehicles traveling the initial flight path encountering delays,
wherein a set of encountered obstacles and encountered delays are determined based on at least one sensor of a traversing aerial vehicle, comprising any of an ultrasound sensor, a radio frequency sensor, a laser sensor, a radar sensor, an optical sensor, a stereo optical sensor, and a LIDAR sensor;
a publish algorithm to publish the flight-path map through at least one of a computing device and a mobile device to the plurality of searching users of a map-sharing community; and
a tracking algorithm to permit at least one of the plurality of searching users to track the traversing aerial vehicle while in flight through a map view of at least one of the computing device and the mobile device.

20. The system of claim 15 further comprising:
a social network server through which a user of the social network server to register an ownership interest in a real property,
wherein the user of the social network server to specify at least one of a permission, a restriction and a rule regarding a flight of the aerial vehicle in an airspace immediately above to the property such that other users of the social network are any one of provided an access privilege and denied the access privilege to operate aerial devices in the airspace above the property,
wherein at least one of the permission, the restriction, and the rule is entered into a safe-flight server database and associated with the airspace above the property,
wherein a flight-path generator algorithm is applied to ensure at least one of the permission, the restriction, and the rule associated with the airspace above the property conforms to at least one of a rule and a regulation of a regulatory entity,
wherein the social network server is associated with a geospatial social network, and
wherein the social network server to verify the ownership interest of the user registering the ownership interest in the real property through a property ownership verification method.
